(19) United States
(12) Patent Application Publication
(10) Pub. No.: US 2016/0305523 A1
(43) Pub. Date: Oct. 20, 2016

(54) HYDROKINETIC TORQUE CONVERTER WITH CRIMPED BLADES AND METHOD FOR MAKING THE SAME

(71) Applicant: VALEO EMBRAYAGES, Amiens Cedex 2 (FR)

(72) Inventor: Alexandre DEPRAETE, Bloomfield, MI (US)

(73) Assignee: VALEO EMBRAYAGES

(21) Appl. No.: 14/689,487

(22) Filed: Apr. 17, 2015

(51) Int. Cl. F16H 41/04; F16H 41/28

(52) U.S. Cl. CPC F16H 41/04; F16H 41/28

(57) ABSTRACT

A hydrokinetic torque converter comprises an impeller rotatable about a rotational axis and a coaxial turbine. The impeller includes an impeller shell, a core ring and a plurality of impeller blades disposed between the impeller shell and the impeller core ring. The turbine includes a turbine shell, a core ring and a plurality of turbine blades disposed between the turbine shell and the turbine core ring. Each of the turbine blades or impeller blades has a rear crimped portion fixedly securing each of the turbine blades or impeller blades to the core ring of the corresponding turbine or impeller by the rear crimped portion. Method for assembling a hydrokinetic torque converter comprising the steps of crimping a rear portion of the impeller blade or turbine blade so as to fixedly securing the impeller blade or turbine blade to corresponding one of the impeller and turbine core rings.

### BACKGROUND OF THE INVENTION

1. Field of the Invention

The present invention generally relates to fluid coupling devices; and more particularly to a hydrokinetic torque converter, and a method for making the same.

2. Description of the Prior Art

Typically, a hydrokinetic torque converter includes an impeller wheel, a turbine wheel, a stator (or reactor) fixed to a casing of the torque converter, and a one-way clutch for restricting a rotational direction of the stator to one direction. The turbine wheel is integral or operatively connected with a hub linked in rotation to a driven shaft, which is itself linked to an input shaft of a transmission of a vehicle. The casing of the torque converter generally includes a front cover and an impeller shell which together define a fluid filled chamber. Impeller blades are fixed to the impeller shell within the fluid filled chamber to define the impeller wheel. The turbine wheel and the stator are also disposed within the chamber, both the turbine wheel and the stator being relatively rotatable with respect to the front cover and the impeller shell. The turbine wheel includes a turbine shell with a plurality of turbine blades fixed to one side of the turbine shell facing the impeller blades of the impeller wheel.

The turbine works together with the impeller wheel, which is linked in rotation to the casing that is linked in rotation to a driving shaft driven by an internal combustion engine. The stator is interposed axially between the turbine and the impeller, and is mounted so as to rotate on the driven shaft with the interposition of the one-way clutch.

Current hydrokinetic torque converters and methods for assembling thereof are quite complex, cumbersome and expensive. Therefore, while conventional hydrokinetic torque converters, including but not limited to that discussed above, have proven to be acceptable for vehicular driveline applications and conditions, improvements that may enhance their performance and cost are possible.

### BRIEF SUMMARY OF THE INVENTION

According to a first aspect of the invention, there is provided a hydrokinetic torque converter, comprising an impeller wheel rotatable about a rotational axis, and a turbine wheel rotatable about the rotational axis and disposed axially opposite to the impeller wheel. The turbine wheel is coaxially aligned with and drivable by the impeller wheel. The impeller wheel includes a concave impeller shell, an impeller core ring and a plurality of impeller blades disposed between the impeller shell and the impeller core ring. The impeller blades are fixedly secured to the impeller core ring. The turbine wheel includes a concave turbine shell, a turbine core ring and a plurality of turbine blades disposed between the turbine shell and the turbine core ring. The turbine blades are fixedly secured to said turbine core ring. Each of at least one of the turbine blades and the impeller blades has a rear crimped portion fixedly securing each of one of the turbine blades and the impeller blades to the core ring of corresponding one of the turbine wheel and the impeller wheel by said rear crimped portion.

According to a second aspect of the present invention, there is provided a hydrokinetic torque converter, comprising an impeller wheel rotatable about a rotational axis, and a turbine wheel rotatable about the rotational axis and disposed axially opposite to said impeller wheel. The turbine wheel is coaxially aligned with and drivable by the impeller wheel. The turbine wheel includes a concave turbine shell, a turbine core ring and a plurality of turbine blades disposed between the turbine shell the said turbine core ring. The turbine blades are fixedly secured to the turbine core ring. Each of the turbine blades has a rear crimped portion fixedly securing each of the turbine blades to the turbine core ring of the turbine wheel by the rear crimped portion. Each of the turbine blades also has at least one front crimped portion fixedly securing each of the turbine blades to the turbine shell of the turbine wheel by the at least one front crimped portion.

According to a third aspect of the present invention, there is provided a method for assembling a hydrokinetic torque converter. The method involves the steps of providing a substantially annular con cave impeller shell or a substantially annular concave turbine shell, providing a substantially annular impeller core ring or a substantially annular turbine core ring, providing an impeller blade or a turbine blade, and crimping a rear portion of the impeller blade or the turbine blade so as to form a rear crimped portion fixedly securing the impeller blade or the turbine blade to corresponding one of the impeller core ring and the turbine core ring.

According to a fourth aspect of the present invention, there is provided a method for assembling a hydrokinetic torque converter. The method involves the steps of providing a substantially annular concave turbine shell, a substantially annular turbine core ring and a turbine blade, crimping a front portion of said turbine blade so as to form a front crimped portion fixedly securing the turbine blade to the impeller shell, and crimping a rear portion of the turbine blade so as to form a rear crimped portion fixedly securing the turbine blade to the turbine core ring.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a fragmentary cross-sectional view of a hydrokinetic torque coupling device in accordance with an exemplary embodiment of the present invention;

FIG. 2 is a perspective view of a core ring of an impeller wheel in accordance with the exemplary embodiment of the present invention;

FIG. 3 is a front view of the core ring of the impeller wheel;

FIGS. 4A-4B are various perspective views of an impeller blade of the impeller wheel in accordance with the exemplary embodiment of the present invention;

FIG. 5 is a fragmentary perspective view from the inside of the core ring of the impeller wheel with the impeller blades mounted thereto before crimping;

FIG. 6 is a fragmentary perspective view from the inside of the core ring of the impeller wheel with the impeller blades mounted thereto after crimping;

FIG. 7 is a perspective view of a turbine shell of a turbine wheel in accordance with the exemplary embodiment of the present invention;

FIG. 8 is a front view of the turbine shell in accordance with the exemplary embodiment of the present invention;

FIG. 9 is a perspective view of a core ring of the turbine wheel in accordance with the exemplary embodiment of the present invention;

FIG. 10 is a front view of the core ring of the turbine wheel;

FIGS. 11A-11C are various perspective views of a turbine blade of the turbine wheel in accordance with the exemplary embodiment of the present invention;

FIG. 12 is a fragmentary perspective view from the outside of the turbine shell of the turbine wheel with the turbine blades mounted thereto before crimping;

FIG. 13 is a fragmentary perspective view from the outside of the turbine shell of the turbine wheel with the turbine blades mounted thereto after crimping;

FIG. 14 is a partial sectional front view of the turbine wheel taken along the line 14-14 in FIG. 13;

FIG. 15 is a fragmentary perspective view from the inside of the core ring of the turbine wheel with the turbine blades according to the alternative embodiment of the present invention, mounted thereto after crimping; and

FIG. 16 is a partial sectional front view of the turbine wheel taken along the line 16-16 in FIG. 15;

FIG. 17 is a fragmentary perspective view from the inside of the core ring of the turbine wheel with the turbine blades mounted thereto before crimping; and

FIG. 18 is a fragmentary perspective view from the inside of the core ring of the turbine wheel with the turbine blades mounted thereto after crimping.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” and “an” as used in the claims means “at least one” and the word “two” as used in the claims means “at least two”.

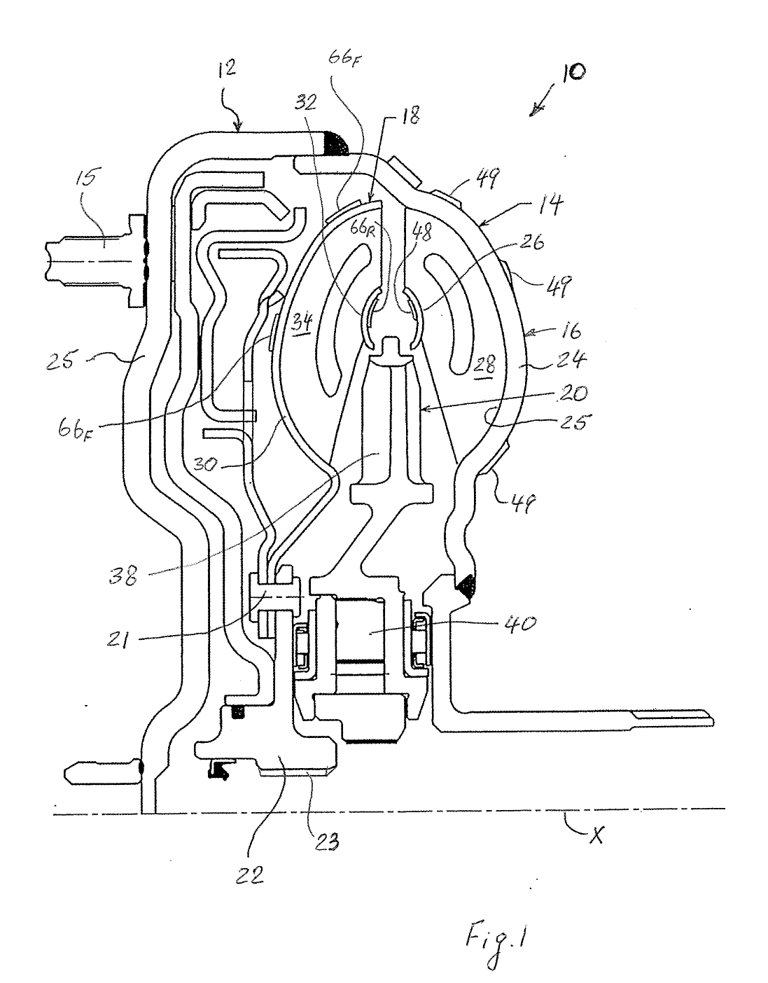

A hydrokinetic torque coupling device is generally represented in the accompanying drawings by reference numeral 10, as best shown in FIG. 1. The hydrokinetic torque coupling device 10 is intended to couple driving and driven shafts, for example in a motor vehicle. In this case, the driving shaft is an output shaft of an internal combustion engine (not shown) of the motor vehicle and the driven shaft is connected to an automatic transmission of the motor vehicle. The hydrokinetic torque coupling device 10 comprises a sealed casing 12 filled with oil and rotatable about a rotational axis X of rotation, and a hydrokinetic torque converter 14 disposed in the casing 12. Hereinafter the axial and radial orientations are considered with respect to the rotational axis X of the torque coupling device 10.

The hydrokinetic torque converter 14 comprises an impeller wheel 16, a turbine wheel 18, and a reactor (or stator) 20 interposed axially between the impeller wheel 16 and the turbine wheel 18. The turbine wheel 18 is non-rotatably secured to a hub member 22 by any appropriate means, such as by rivets 21 or welding. The hub member 22 is non-rotatably attached to the driven shaft with splines 23. The hub member 22 is rotatable about the axis X and is coaxial with the driven shaft so as to center the turbine wheel 18 on the driven shaft.

The impeller wheel 16 includes a substantially annular, semi-toroidal (or concave) impeller shell 24 formed integrally with a front side wall of the casing 12, a substantially annular impeller core ring 26, and a plurality of impeller blades (or vanes) 28 non-movably (i.e., fixedly) secured between the impeller shell 24 and the core ring 26 of the impeller wheel 16.

The turbine wheel 18 includes a substantially annular, semi-toroidal (or concave) turbine shell 30, a substantially annular turbine core ring 32, and a plurality of turbine blades (or vanes) 34 non-movably (i.e., fixedly) secured between the turbine shell 30 and the core ring 32 of the turbine wheel 18. The turbine shell 30 is made by press-forming from a sheet metal material.

The stator 20 is rotatably mounted to stator shaft (not shown) through a one-way (or overrunning) clutch 40. The one-way clutch 40 permits rotation of the stator 20 in one direction only. The stator 20 includes an annular stator hub 36 and a plurality of stator blades (or vanes) 38 radially outwardly extending from the stator hub 36 and non-movably (i.e., fixedly) secured thereto. Conventionally, the impeller blades 28 of the impeller wheel 16 are provided to interact, in a known manner, with the turbine blades 34 of the turbine wheel 18 and the stator blades 38 of the stator 20.

The casing 12 consists of two casing portions, which are connected sealingly together at their outer periphery. One of the casing portions includes a front cover 25, which extends generally transversely in a plane at right angles to the rotational axis X, i.e., radially. Another casing portion of the casing 12 is so configured as to constitute the impeller shell 24 of the impeller wheel 16. The impeller shell 24 is non-rotatably (i.e., fixedly) secured to the front cover 25, such as by welding. In turn, the front cover 25 is rotatably driven by the engine and is non-rotatably coupled to a crankshaft thereof with studs 15. Each of the front cover 25 and the impeller shell 24 is made integrally by press-forming in one piece, from sheet metal material.

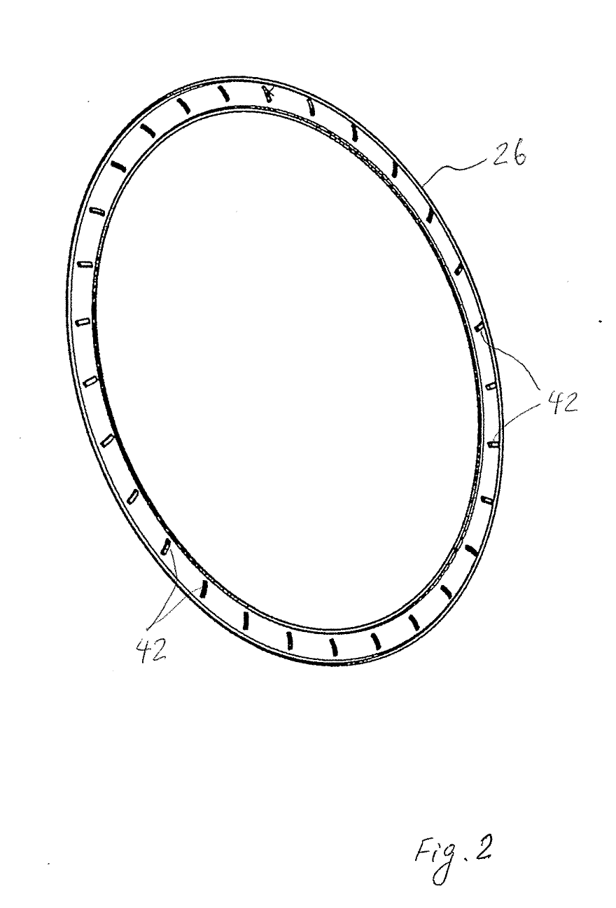

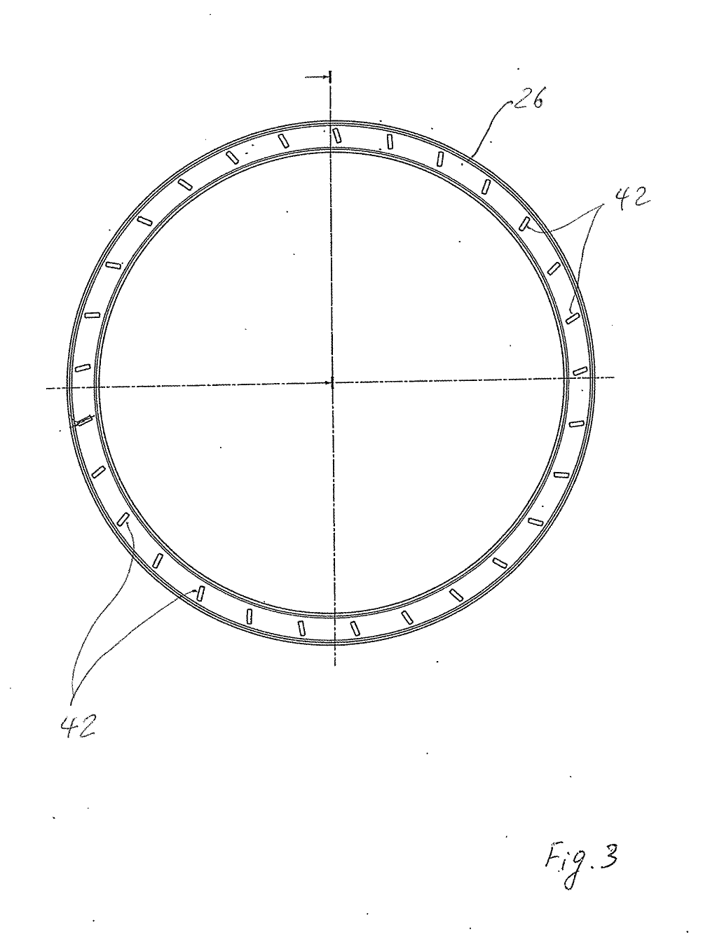

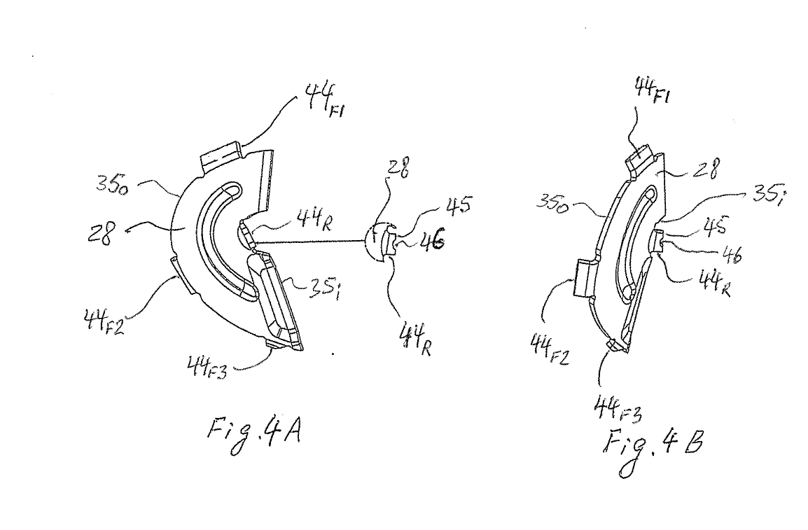

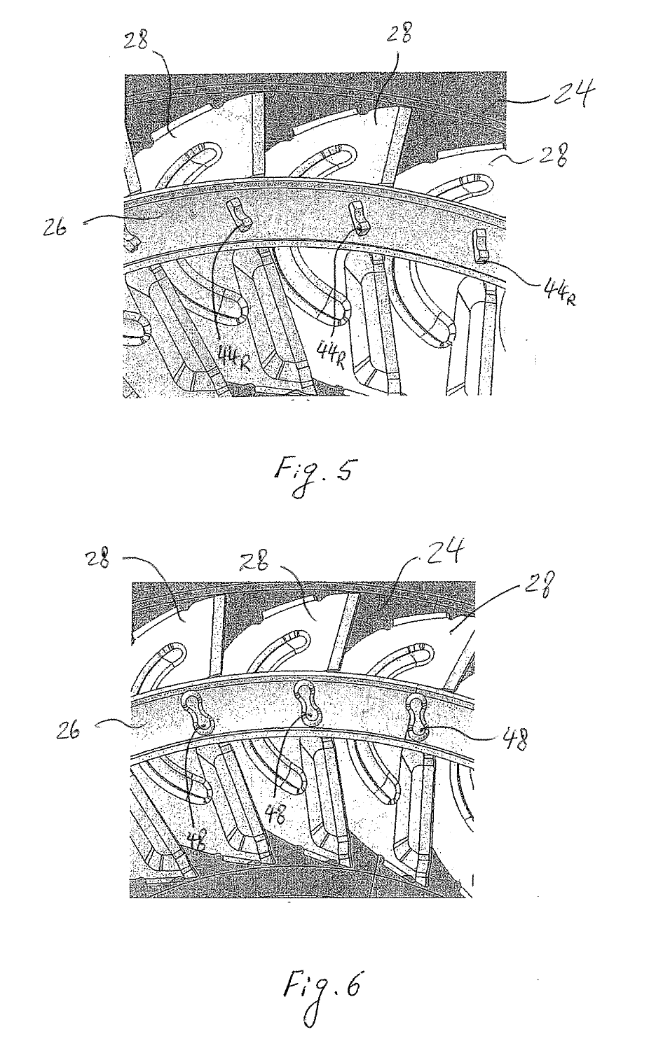

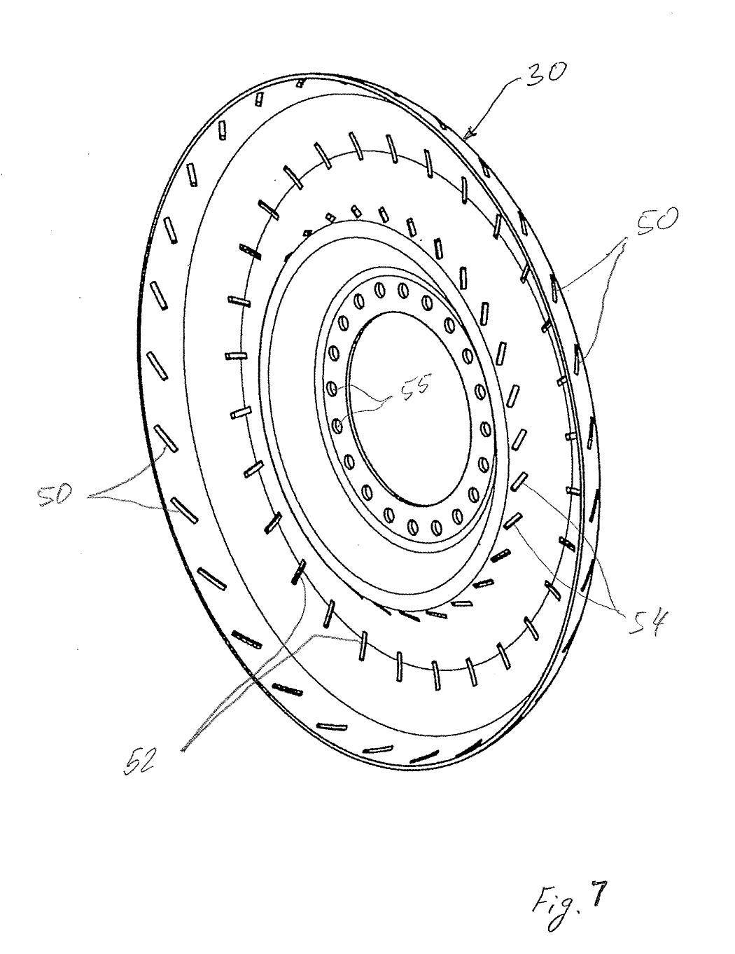

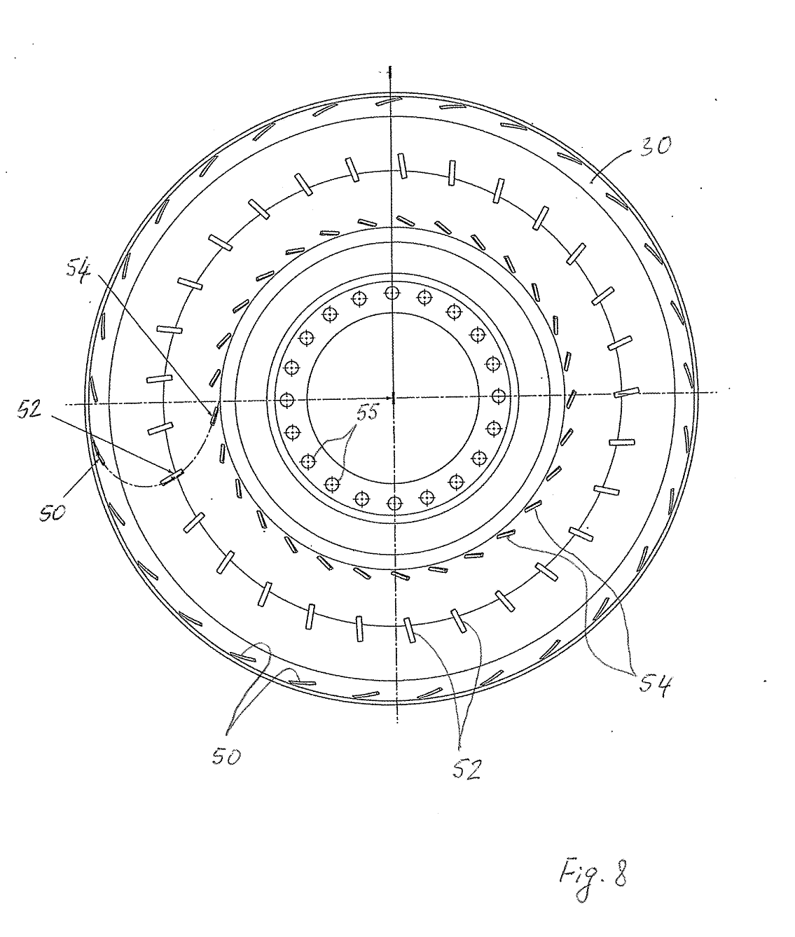

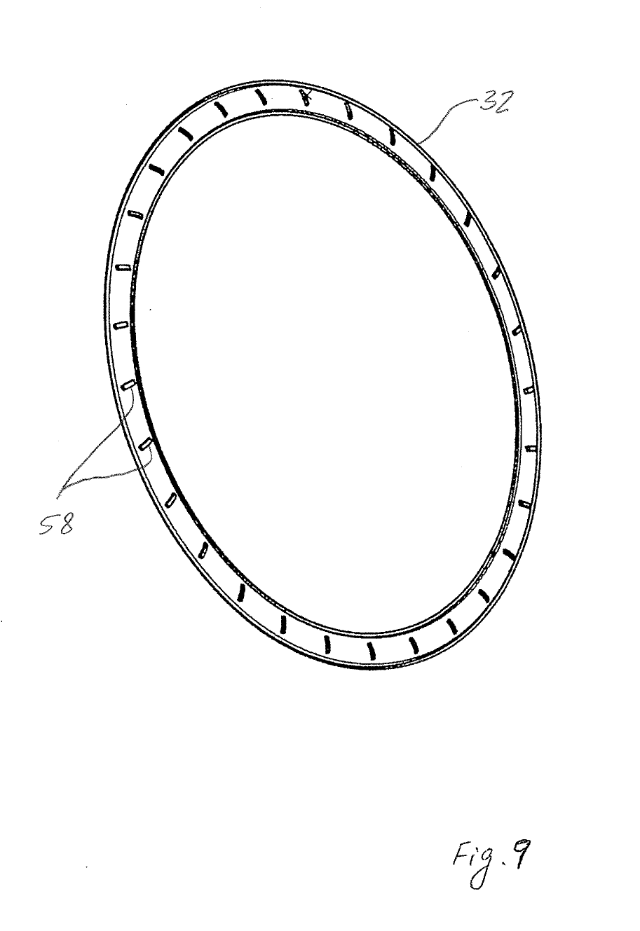

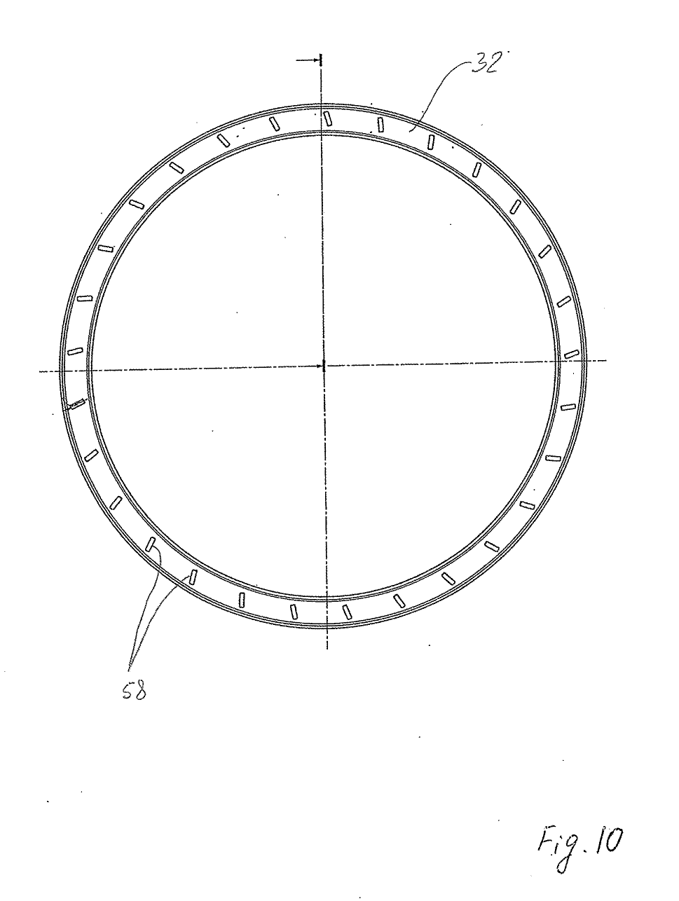

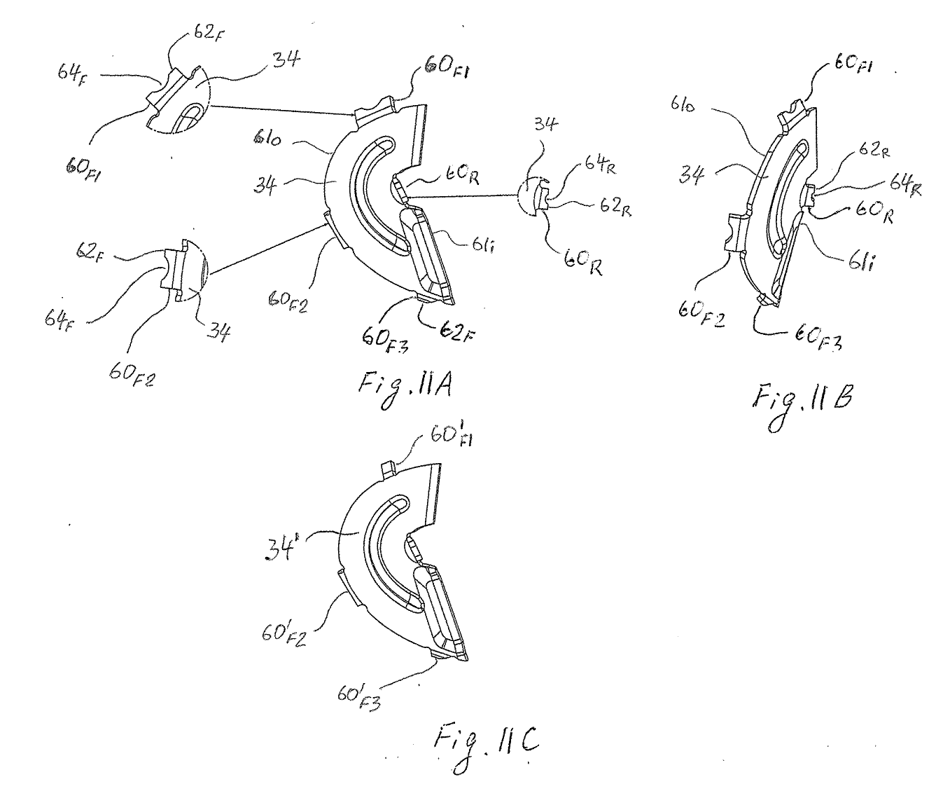

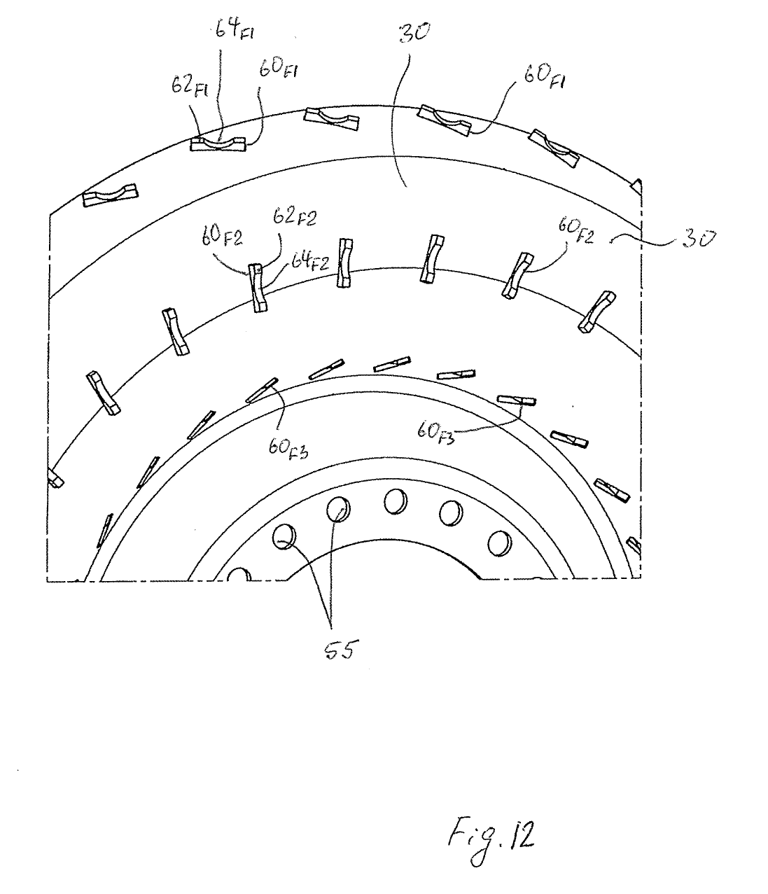

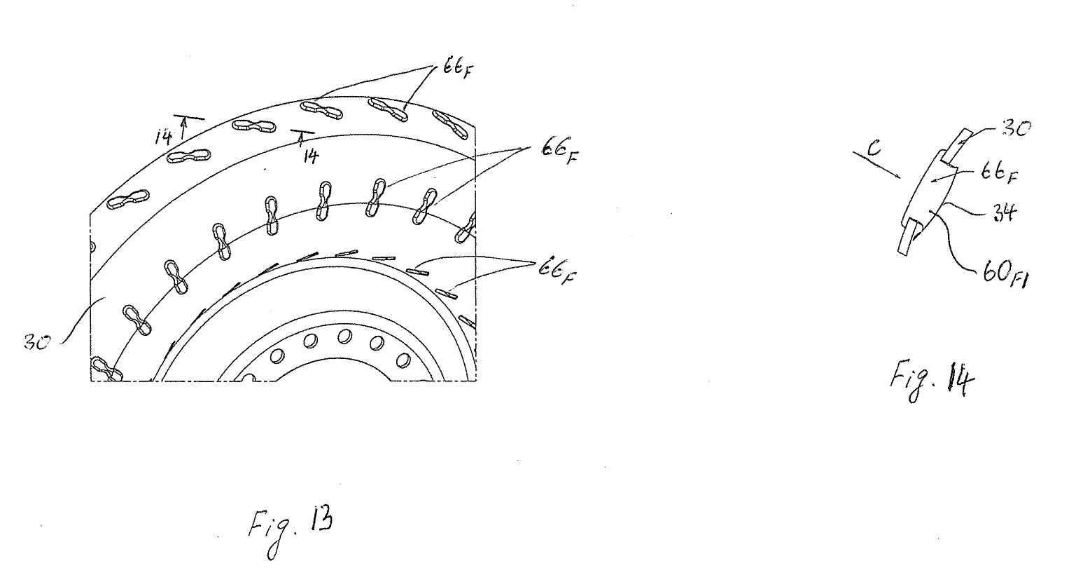

As noted above, the impeller blades 28 of the impeller wheel 16 are fixedly secured to both the impeller shell 24 and the impeller core ring 26 of the impeller wheel 16. Specifically, as best shown in FIGS. 2-3, the impeller core ring 26 of the impeller wheel 16 is provided with a plurality of slots 42 formed through the impeller core ring 26. In turn, each of the impeller blades 28 includes one or more, such as three, front mounting tabs 44_{F1}-44_{F3} formed integrally therewith on an axially outer surface 35o of the impeller blade 28. The axially outer surface 35o of the impeller blade 28 faces and engages the impeller shell 24 in an assembled state of the torque converter 14. Similarly, each of the impeller blades 28 includes at least one rear mounting tab 44_{R} formed integrally therewith on an axially inner surface 35i of the impeller blade 28, and configured to be received and retained in the slots 42 in the core ring 26 of the impeller wheel 16. The axially inner surface 35i of the impeller blade 28 faces and engages the impeller core ring 26 in an assembled state of the torque converter 14. According to the exemplary embodiment of the present invention, each of the impeller blades 28 is integrally formed with the front mounting tabs 44_{F1}-44_{F3} and the rear mounting tab 44_{R} as a single-piece part, such as by stamping. As best shown in FIGS. 4A and 4B, an axially distal end portion 45 of the rear mounting tab 44_{R} is provided with a central recess (or indentation) 46 formed in a central portion of the distal end portion 45. Location of the slots 42 on the core ring 26 is complementary to the location of the rear mounting tabs 44_{R} on the impeller blades 28.

The impeller blades 28 of the impeller wheel 16 are secured to the core ring 26 of the impeller wheel 16 by a crimping action in such a manner as to fixedly (i.e., non-movably) attach the impeller blades 28 to the core ring 26. As best shown in FIG. 6, a rear crimped portion of the distal end portion 45 of each of the rear mounting tab 44_{R} of the impeller blades 28 is represented by reference numeral 48.

Described below is an exemplary method whereby the impeller wheel 16 of the hydrokinetic torque converter 14 according to the exemplary embodiment of the present invention is assembled. It should be understood that alternative methods may be practiced within the scope of the invention.

First, the impeller shell 24 is provided with a series of recesses defined upon an interior surface 25 of the impeller shell 24. Second, the impeller blades 28 are provided, each formed as a single-piece part with the integral front mounting tabs 44_{F1}-44_{F3} and the rear mounting tab 44_{R}. The impeller blades 28 are fixed to the impeller shell 24 by inserting the front mounting tabs 44_{F1}-44_{F3} into these recesses and brazing the front mounting tabs 44_{F1}-44_{F3 to} the impeller shell 24. It is to be understood that other techniques of securing the front mounting tabs 44_{F1}-44_{F3}, such as soldering, welding, or adhesive bonding may be employed

Then, the core ring 26 of the impeller wheel 16 with the slots 42 is provided. Next, the core ring 26 is mounted to the impeller blades 28 so the each of the rear mounting tab 44_{R} of the impeller blades 28 is fitted in the corresponding slots 42 in the core ring 26 of the impeller wheel 16, as best shown in FIG. 5. As further illustrated in FIG. 5, the rear mounting tabs 44_{R} of the impeller blades 28 are received in the slots 42 in the core ring 26 so that the distal end portion 45 of each of the rear mounting tab 44_{R} of the impeller blades 28 extends through the corresponding slots 42 in the core ring 26, and so that the distal end portion 45 of each of the rear mounting tab 44_{R} of the impeller blades 28 is disposed outside the core ring 26.

After that, the distal end portion 45 of each of the rear mounting tab 44_{R} of the impeller blades 28 is deformed axially inwardly in the direction toward the impeller shell 24 by a crimping operation to form the rear crimped portion 48, as best shown in FIG. 6. The impeller blades 28 of the impeller wheel 16 are thereby fixedly (i.e., non-movably) secured to the core ring 26 and the impeller shell 24 of the impeller wheel 16 so as to be disposed between the core ring 26 and the impeller shell 24 of the impeller wheel 16. It will be appreciated that the central recess 46 formed in the distal end portion 45 provides a superior connection of the impeller blades 28 with the core ring 26. A press-crimping operation may be used to deform the distal end portion 45 of each of the rear mounting tab 44_{R} of the impeller blades 28 so as to create the deformed, rear crimped portion 48 shown in FIG. 6.

As noted above, the turbine blades 34 of the turbine wheel 18 are fixedly secured to both the turbine shell 30 and the core ring 32 of the turbine wheel 18. Specifically, as best shown in FIGS. 7-8, a plurality of outer slots 50 arranged in the circumferential direction and circumferentially spaced from each other, a plurality of middle slots 52 arranged in the circumferential direction and circumferentially spaced from each other, and a plurality of inner slots 54 arranged in the circumferential direction and circumferentially spaced from each other. As further illustrated in FIGS. 7-8, the outer slots 50, the middle slots 52 and the inner slots 54 are radially spaced from each other. An inner peripheral portion of the turbine shell 30 is fixed to the hub member 22, such as by the rivets 21 extending through holes 55 formed through the inner peripheral portion of the turbine shell 30. Moreover, as best shown in FIGS. 9-10, the core ring 32 of the turbine wheel 18 is provided with a plurality of slots 58 formed through the core ring 32.

In turn, each of the turbine blades 34 includes one or more, such as three, front mounting tabs 60_{F1}-60_{F3} formed integrally therewith on an axially outer surface 610 of the turbine blade 34, and configured to be received and retained in the outer slots 50, the middle slots 52 and the inner slots 54, respectively, in the turbine shell 30 of the turbine wheel 18. The axially outer surface 610 of the turbine blade 34 faces and engages the turbine shell 30 in an assembled state of the torque converter 14. As best shown in FIGS. 11A and 11B, an axially distal end portion 62_{F} of each of the front mounting tabs 60_{F1} and 60_{F2} is provided with a central recess (or indentation) 64_{F} formed in a central portion of the distal end portion 62_{F} thereof. As illustrated in FIGS. 11C and 15, turbine blades 34′ according to the alternative embodiment of the present invention have substantially rectangular front mounting tabs 60′_{F1} and 60′F₂. Location of the slots 50, 52 and 54 on the turbine shell 30 is complementary to the location of the front mounting tabs 60_{F1}-60_{F3} on the turbine blades 34.

Similarly, each of the turbine blades 34 includes at least one rear mounting tab 60_{R} formed integrally therewith on an axially inner surface 610 of the turbine blade 34, and configured to be received and retained in the slots 58 in the core ring 32 of the turbine wheel 18. The axially inner surface 61i of the turbine blade 34 faces and engages the turbine core ring 32 in an assembled state of the torque converter 14. As best shown in FIGS. 11A and 11B, an axially distal end portion 62_{R} of the rear mounting tab 60_{R} is provided with a central recess (or indentation) 64_{R} formed in a central portion of the distal end portion 62_{R}. Location of the slots 58 on the core ring 32 is complementary to the location of the rear mounting tabs 60_{R} on the turbine blades 34.

According to the exemplary embodiment of the present invention, each of the turbine blades 34 is integrally formed with the front mounting tabs 6_{0F1}-6_{0F3} and the rear mounting tab 6_{0R} as a single-piece part, such as by stamping.

The turbine blades 34 of the turbine wheel 18 are secured to the turbine shell 30 and the turbine core ring 32 of the turbine wheel 18 by a crimping action in such a manner as to fixedly (i.e., non-movably) attach the turbine blades 34 to the turbine shell 30 and the turbine core ring 32. As best shown in FIGS. 13-16 and 18, a front crimped portion of the distal end portion 62_{F} of each of the front mounting tabs 60_{F1}-60_{F3} of the turbine blades 34 is represented by reference numeral 66_{F}, while a rear crimped portion of the distal end portion 62_{R} of each of the rear mounting tab 60_{R} of the turbine blades 34 is represented by reference numeral 66_{R}.

Described below is an exemplary method whereby the turbine wheel 18 of the hydrokinetic torque converter 14 according to the exemplary embodiment of the present invention is assembled. It should be understood that alternative methods may be practiced within the scope of the invention.

First, the turbine shell 30 is provided with the outer slots 50, the middle slots 52 and the inner slots 54 therethrough. Second, the turbine blades 34 are provided, each formed as a single-piece part with the integral front mounting tabs 60_{F1}-60_{F3} and the rear mounting tab 60_{R}. The turbine blades 34 are mounted to the turbine shell 30 by inserting the front mounting tabs 60_{F1}-60_{F3} into the corresponding outer slots 50, middle slots 52 and inner slots 54 in the turbine shell 30, as best shown in FIG. 12. As further illustrated in FIG. 12, the front mounting tabs 60_{F1}-60_{F3} of the turbine blades 34 are received in the slots 50, 52 and 54 in the turbine shell 30 so that the distal end portion 62_{F} of each of the front mounting tabs 60_{F1}-60_{F3} of the turbine blades 34 extends through the turbine shell 30, and so that the distal end portion 62_{F} of each of the front mounting tabs 60_{F1}-60_{F3} of the turbine blades 34 is disposed outside the turbine shell 30.

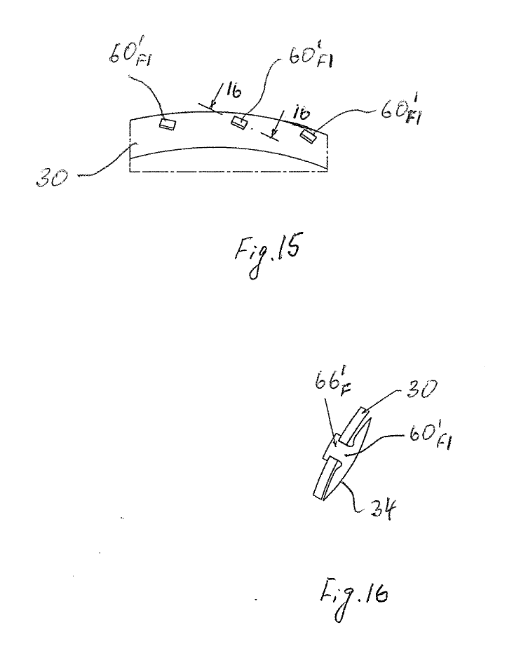

After that, the crimping force is applied by a crimping tool to the distal end portion 62_{F} of each of the front mounting tabs 60_{F1}-60_{F3} of the turbine blades 34 in the direction C (shown in FIG. 14) toward an outer peripheral surface 30a of the turbine shell 30 so that the distal end portion 62_{F} of each of the front mounting tabs 60_{F1}-60_{F3} of the turbine blades 34 is deformed axially inwardly in the direction C (shown in FIG. 14) by a crimping operation to form the front crimped portion 66_{F}, as best shown in FIGS. 13 and 14. FIG. 16 illustrates a front crimped portion 66′_{F} of the turbine blade 34′ according to the alternative embodiment of the present invention. The turbine blades 34 of the turbine wheel 18 are thereby fixedly (i.e., non-movably) secured to the turbine shell 30 of the turbine wheel 18. It will be appreciated that the central recess 64_{F} formed in the distal end portion 62_{F} provides a superior connection of the turbine blades 34 with the turbine shell 30. A press-crimping operation may be used to deform the distal end portion 62_{F} of each of the r front mounting tabs 60_{F1}-60_{F3} of the turbine blades 34 so as to create the deformed, front crimped portion 66_{F}, shown in FIGS. 13 and 14.

Next, the turbine core ring 32 of the turbine wheel 18 with the slots 58 is provided. The turbine core ring 32 is mounted to the turbine blades 34 so the each of the rear mounting tab 60_{R} of the turbine blades 34 is fitted in the corresponding slots 58 in the turbine core ring 32 of the turbine wheel 18, as best shown in FIG. 17. As further illustrated in FIG. 17, the rear mounting tabs 60_{R} of the turbine blades 34 are received in the slots 58 in the turbine core ring 32 so that the distal end portion 62_{R} of each of the rear mounting tab 60_{R} of the turbine blades 34 extends through the turbine core ring 32, and so that the distal end portion 62_{R} of each of the rear mounting tab 60_{R} of the turbine blades 34 is disposed outside the turbine core ring 32.

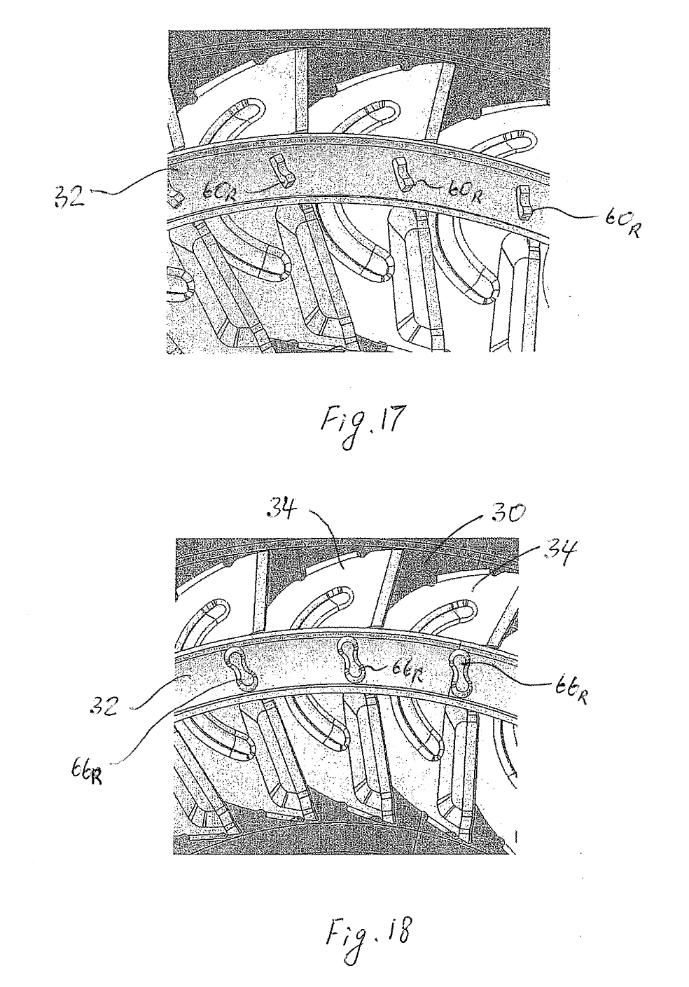

After that, the distal end portion 62_{R} of each of the rear mounting tab 60_{R} of the turbine blades 34 is deformed axially inwardly in the direction toward an inner peripheral surface 30b of the turbine shell 30 by a crimping operation to form the rear crimped portion 66_{R}, as best shown in FIG. 18. The turbine blades 34 of the turbine wheel 18 are thereby fixedly (i.e., non-movably) secured to the turbine core ring 32 and the turbine shell 30 of the turbine wheel 18 so as to be disposed between the turbine core ring 32 and the turbine shell 30 of the turbine wheel 18. It will be appreciated that the central recess 64_{R} formed in the distal end portion 62_{R} provides a superior connection of the turbine blades 34 with the turbine core ring 32. A press-crimping operation may be used to deform the distal end portion 62_{R} of each of the rear mounting tab 60_{R} of the turbine blades 34 so as to create the deformed, rear crimped portion 66_{R} shown in FIG. 18.

Therefore, the present invention provides a novel hydrokinetic torque converter and method for assembling thereof that simplifies and optimizes the assembly process, and makes it cost effective. Moreover, the present invention increases turbine wheel and impeller wheel stiffness.

The foregoing description of the exemplary embodiment(s) of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A hydrokinetic torque converter, comprising:
an impeller wheel rotatable about a rotational axis; and
a turbine wheel rotatable about said rotational axis and disposed axially opposite to said impeller wheel, said turbine wheel coaxially aligned with and drivable by said impeller wheel;
said impeller wheel including a concave impeller shell, an impeller core ring and a plurality of impeller blades disposed between said impeller shell and said impeller core ring, said impeller blades fixedly secured to said impeller core ring;
said turbine wheel including a concave turbine shell, a turbine core ring and a plurality of turbine blades disposed between said turbine shell and said turbine core ring, said turbine blades fixedly secured to said turbine core ring;
each of at least one of said turbine blades and said impeller blades having a rear crimped portion fixedly securing each of one of said turbine blades and said impeller blades to said core ring of corresponding one of said turbine wheel and said impeller wheel by said rear crimped portion.

2. The torque converter as defined in claim 1, wherein each of said impeller blades or said turbine blades has a rear mounting tab formed integrally therewith on an axially inner surface thereof, wherein said impeller core ring or said turbine core ring includes a plurality of slots receiving said rear mounting tabs of said impeller blades or said turbine blades therethrough, and wherein said rear crimped portion is formed at an axially distal end portion of said rear mounting tab of each of said impeller blades or said turbine blades.

3. The torque converter as defined in claim 1, wherein each of said turbine blades has at least one front crimped portion fixedly securing each of said turbine blades to said turbine shell of said turbine wheel by said at least one front crimped portion.

4. The torque converter as defined in claim 3, wherein each of said turbine blades has at least one front mounting tab formed integrally therewith on an axially outer surface thereof, wherein said turbine shell includes a plurality of slots receiving said front mounting tabs of said turbine blades therethrough, and wherein said at least one front crimped portion is formed at an axially distal end portion of said at least one front mounting tab of each of said turbine blades.

5. A method for assembling a hydrokinetic torque converter, the method comprising the steps of:
providing a substantially annular concave impeller shell or a substantially annular concave turbine shell;
providing a substantially annular impeller core ring or a substantially annular turbine core ring;
providing an impeller blade or a turbine blade; and
crimping a rear portion of said impeller blade or said turbine blade so as to form a rear crimped portion fixedly securing said impeller blade or said turbine blade to corresponding one of said impeller core ring and said turbine core ring.

6. The method as defined in claim 5, wherein said impeller blade or said turbine blade has a rear mounting tab formed integrally therewith on an axially inner surface thereof, wherein said impeller core ring or said turbine core ring includes a slot, and wherein said method further including the step of inserting said rear mounting tab of said impeller blade or said turbine blade into said slot in said impeller core ring or said turbine core ring, followed by the step of crimping said rear portion of said impeller blade or said turbine blade to fixedly secure said impeller blade or said turbine blade to corresponding one of said impeller core ring and said turbine core ring.

7. The method as defined in claim 6, wherein said rear mounting tab of said impeller blade or said turbine blade is inserted into said slot in said impeller core ring or said turbine core ring so that an axially distal end portion of said rear mounting tab extends through said slot in said impeller core ring or said turbine core ring, and so that said axially distal end portion of said rear mounting tab of said impeller blade or said turbine blade is disposed outside said impeller core ring or said turbine core ring.

8. The method as defined in claim 7, wherein the step of crimping said rear portion of said impeller blade or said turbine blade includes the step of crimping said axially distal end portion of said rear mounting tab of said impeller blade or said turbine blade so as to form said rear crimped portion.

9. The method as defined in claim 8, wherein said axially distal end portion of said rear mounting tab of said impeller blade or said turbine blade is provided with a central recess formed in a central portion of said axially distal end portion thereof.

10. The method as defined in claim 5, further comprising the step of crimping at least one front portion of said turbine blade so as to form at least one front crimped portion fixedly securing said turbine blade to said impeller shell.

11. The method as defined in claim 10, wherein said turbine blade has at least one front mounting tab formed integrally therewith on an axially outer surface thereof, wherein said turbine shell includes at least one slot, and wherein said method further comprising the step of inserting said at least one front mounting tab of said turbine blade into said at least one slot in said turbine shell, followed by the step of crimping said at least one front mounting tab of said turbine blade so as to form said at least one front crimped portion fixedly securing said turbine blade to said turbine shell.

12. The method as defined in claim 11, wherein said at least one front mounting tab of said turbine blade is inserted into said slot in said turbine shell so that an axially distal end portion of said at least one front mounting tab extends through said slot in said turbine shell, and so that said axially distal end portion of said at least one front mounting tab of said turbine blade is disposed outside said turbine shell.

13. The method as defined in claim 12, wherein the step of crimping at least one front mounting tab of said turbine blade includes the step of crimping said axially distal end portion of said at least one front mounting tab of said turbine blade so as to form said front crimped portion.

14. The method as defined in claim 13, wherein said axially distal end portion of said at least one front mounting tab of said turbine blade is provided with a central recess formed in a central portion of said axially distal end portion thereof.

15. The method as defined in claim 5, further comprising the step of crimping a plurality of front portions of said turbine blade so as to form a plurality of front crimped portions fixedly securing said turbine blade to said impeller shell.

16. The method as defined in claim 10, wherein said turbine blade has a plurality of front mounting tabs formed integrally therewith on an axially outer surface thereof, wherein said turbine shell includes a plurality of slots, and wherein said method further comprising the step of inserting said front mounting tabs of said turbine blade into said slots in said turbine shell, followed by the step of crimping said front mounting tabs of said turbine blade so as to form said front crimped portions fixedly securing said turbine blade to said turbine shell.

17. The method as defined in claim 16, wherein said front mounting tabs of said turbine blade are inserted into said slots in said turbine shell so that an axially distal end portion of each said front mounting tabs extends through one of said slots in said turbine shell, and so that said axially distal end portion of each of said front mounting tabs of said turbine blade is disposed outside said turbine shell.

18. The method as defined in claim 17, wherein the step of crimping said front mounting tabs of said turbine blade includes the step of crimping said axially distal end portion of each of said front mounting tabs of said turbine blade so as to form said front crimped portions.

19. The method as defined in claim 18, wherein said axially distal end portion of each of said front mounting tabs of said turbine blade is provided with a central recess formed in a central portion of said axially distal end portion thereof.

20. A method for assembling a hydrokinetic torque converter, the method comprising the steps of:
providing a substantially annular concave turbine shell, a substantially annular turbine core ring and a turbine blade;
crimping a front portion of said turbine blade so as to form a front crimped portion fixedly securing said turbine blade to said impeller shell; and
crimping a rear portion of said turbine blade so as to form a rear crimped portion fixedly securing said turbine blade to said turbine core ring.
